(19) United States
(12) Patent Application Publication
(10) Pub. No.: US 2007/0294317 A1
(43) Pub. Date: Dec. 20, 2007

(54) Apparatus and Method for Journaling and Recovering Indexes that Cannot be Fully Recovered During Initial Program Load

(76) Inventors: Dan Allan Christy, Rochester, MN (US); Chad Allen Olstad, Rochester, MN (US); Wilson Paul Ward, Wabasha, MN (US); David Rolland Welsh, Byron, MN (US); Larry William Youngren, Rochester, MN (US)

Correspondence Address: MARTIN & ASSOCIATES, LLC, P.O. BOX 548, CARTHAGE, MO, 64836-0548, US

(21) Appl. No.: 11/424,321

(22) Filed: Jun. 15, 2006

(51) Int. Cl. G06F 17/30

(52) U.S. Cl. 707/202

(57) ABSTRACT

An index recovery mechanism recovers all indexes that were journaled and may be fully recovered during IPL. In addition, the index recovery mechanism performs a first stage of processing for any index that was journaled but cannot be fully recovered during IPL. The first stage processing includes storing index recovery data for an index during IPL. Once IPL is complete, the index recovery mechanism performs a second stage of processing by reading the index recovery data that was stored during IPL, and completing recovery of the index. By performing this two-stage index recovery, the first stage during IPL and the second stage post-IPL, indexes that cannot be fully recovered during IPL can still be journaled and recovered.

### BACKGROUND OF THE INVENTION

1. Field of the Invention

This invention generally relates to database systems, and more specifically relates to an apparatus and method for journaling and recovering indexes.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records are returned as the query result. Auxiliary data structures such as indexes may be built to speed the execution of a query. By using indexes, a database system may process certain queries more efficiently.

Journaling systems have been developed that allow recovery of a database when a failure occurs. Indexes for large database tables may be quite large themselves. For this reason, some indexes are typically journaled along with the database tables to allow recovering an index from the journal if a failure occurs. This saves the database system from the work of generating the index anew from scratch.

Journal recovery usually occurs during initial program load (IPL), which is when the computer system initially boots up. It is best done at this time before other activity begins to occur to the affected objects. Some objects, such as certain types of indexes, cannot be recovered during IPL. For example, some indexes may include a user-defined function (UDF) that is not available during IPL, but is only available after IPL is complete. If an index cannot be recovered during IPL, the index is not journaled, and regeneration of the index from scratch is required after IPL is complete. Without a way to journal and recover indexes that cannot be fully recovered during IPL, the database industry will continue to require full regeneration of these indexes from scratch after IPL is complete.

### BRIEF SUMMARY OF THE INVENTION

An index recovery mechanism recovers all indexes that were journaled and may be fully recovered during IPL. In addition, the index recovery mechanism performs a first stage of processing for any index that was journaled but cannot be fully recovered during IPL. The first stage processing includes storing index recovery data for an index during IPL. Once IPL is complete, the index recovery mechanism performs a second stage of processing by reading the index recovery data that was stored during IPL, and completing recovery of the index. By performing this two-stage index recovery, the first stage during IPL and the second stage post-IPL, indexes that cannot be fully recovered during IPL can still be journaled and recovered.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a flow diagram of a prior art method for journaling indexes;

FIG. 3 is a flow diagram of a prior art method for recovering journaled indexes;

FIG. 4 is a flow diagram of a method for journaling indexes in accordance with the preferred embodiments;

FIG. 5 is a flow diagram of a method for recovering journaled indexes in two stages in accordance with the preferred embodiments;

FIG. 6 is a sample database table;

FIG. 7 is a sample index for the database table in FIG. 7 built over the Name field;

FIG. 8 shows sample IPL index recovery data for the index in FIG. 7 that is generated and stored during a first stage of processing during IPL; and

FIG. 9 shows the index that is generated from the IPL index recovery data shown in FIG. 8 during a second stage of processing that is performed after IPL is complete.

### DETAILED DESCRIPTION OF THE INVENTION

There are many different types of databases known in the art. The most common is known as a relational database (RDB), which organizes data in tables that have rows that represent individual entries or records in the database, and columns that define what is stored in each entry or record.

To be useful, the data stored in databases must be able to be efficiently retrieved. The most common way to retrieve data from a database is to generate a database query. For example, lets assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix.

Sometimes it is helpful to build an index to access data in a database table. An index typically has a primary key whose value determines the order of records in the index. Thus, if the employee table referenced above included a field for an employee's age, an index over the age field would reference all of the records in the table in an order determined by the age of the employee. Let's assume the age index is ordered from lowest to highest age. If a query looks for employees that are more than some specified age, using the index over the age column would be a very efficient way to process the query.

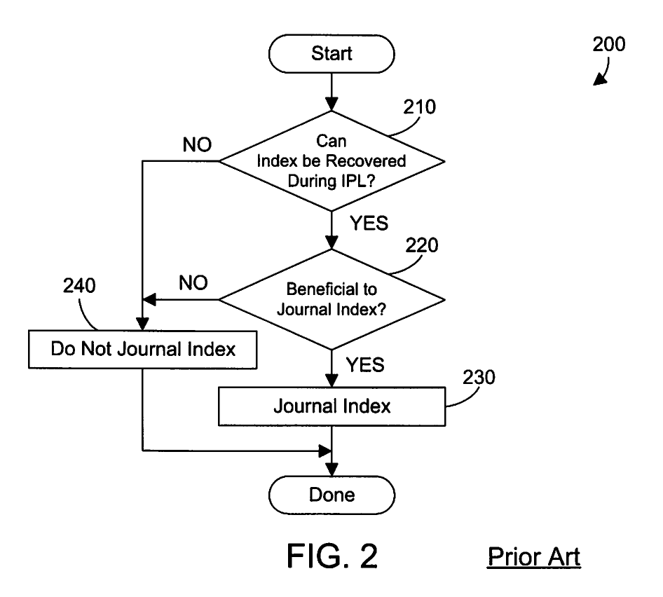

If is often beneficial to journal large indexes so these indexes may be regenerated from journal data if a database error occurs instead of having to regenerate the index from scratch. In the prior art, index recovery is done during IPL, so an index is only journaled if it can be fully recovered during IPL. Referring to FIG. 2, a prior art method 200 begins by determining whether an index can be recovered during IPL (step 210). If not (step 210=NO), the index is not journaled (step 240), and method 200 is done. The prior art method 200 recognizes that it does not make sense to journal an index that cannot be fully recovered during IPL. If the index can be fully recovered during IPL (step 210=YES), and if it is beneficial to journal the index (step 220=YES), the index is journaled (step 230), which means that journal data is collected for the index that allows recovery of the index from the journal data instead of having to regenerate the index from scratch. Note that the decision of whether or not it is beneficial to journal an index in step 220 may be performed using any known criteria or heuristic. One example of a suitable heuristic is to assume it is beneficial to journal any index that is greater that a specified size, or any index built over a table that is greater than a specified size. Another example of a suitable heuristic is to set a threshold for the estimated rebuild time for an index, where an index is journaled if its estimated rebuild time exceeds the threshold.

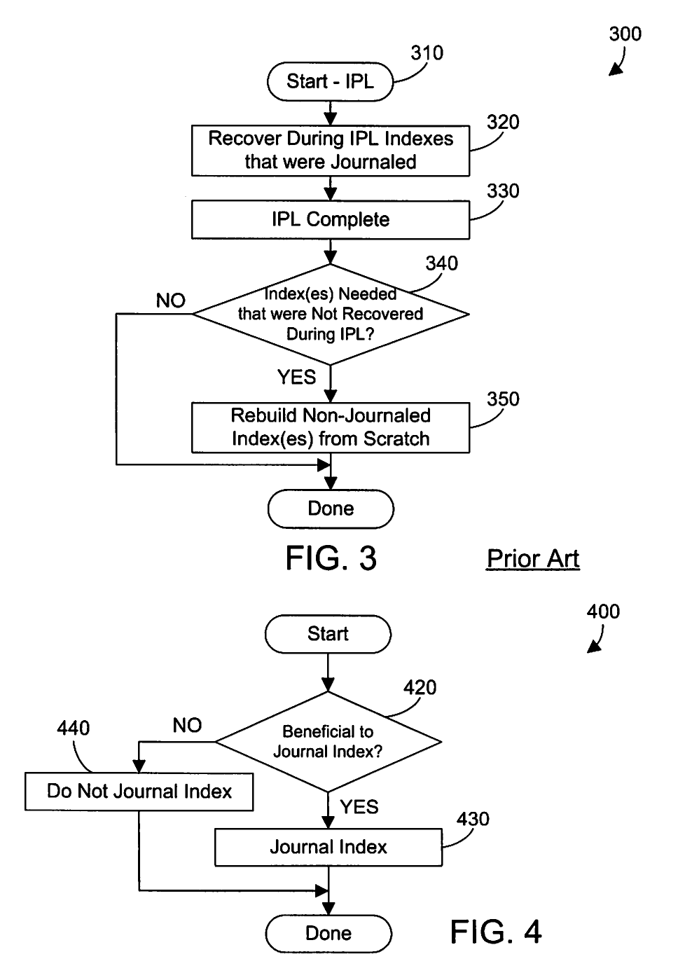

Referring to FIG. 3, a prior art method for recovering journaled indexes starts during IPL (step 310). All indexes that were journaled are recovered during IPL (step 320). Then IPL completes (step 330). Once IPL is complete, method 300 determines whether any index is needed that was not recovered during IPL (step 340). If not (step 340=NO), method 300 is done. If one or more indexes are needed that were not recovered during IPL (step 340=YES), these indexes, which were not journaled because they could not be fully recovered during IPL, must be regenerated (or rebuilt) from scratch (step 350). Note that prior art method 200 and 300 in FIGS. 2 and 3, respectively, are greatly simplified, and it will be understood by one of ordinary skill in the art that other additional steps may also be performed, as is known in the art. Methods 200 and 300 are simplified to effectively illustrate the differences between the prior art and the methods in accordance with the preferred embodiments.

The preferred embodiments provide a significant enhancement to known index journaling by providing a two-stage approach to recovering indexes that cannot be fully recovered during IPL. In a first stage during IPL, data is generated and is stored as IPL index recovery data. After IPL is complete, the IPL index recovery data is read and used to perform a second stage of processing that completes recovery of the index. In this manner, indexes that cannot be fully recovered during IPL may still be journaled and recovered using this two-stage process, which is described in more detail below.

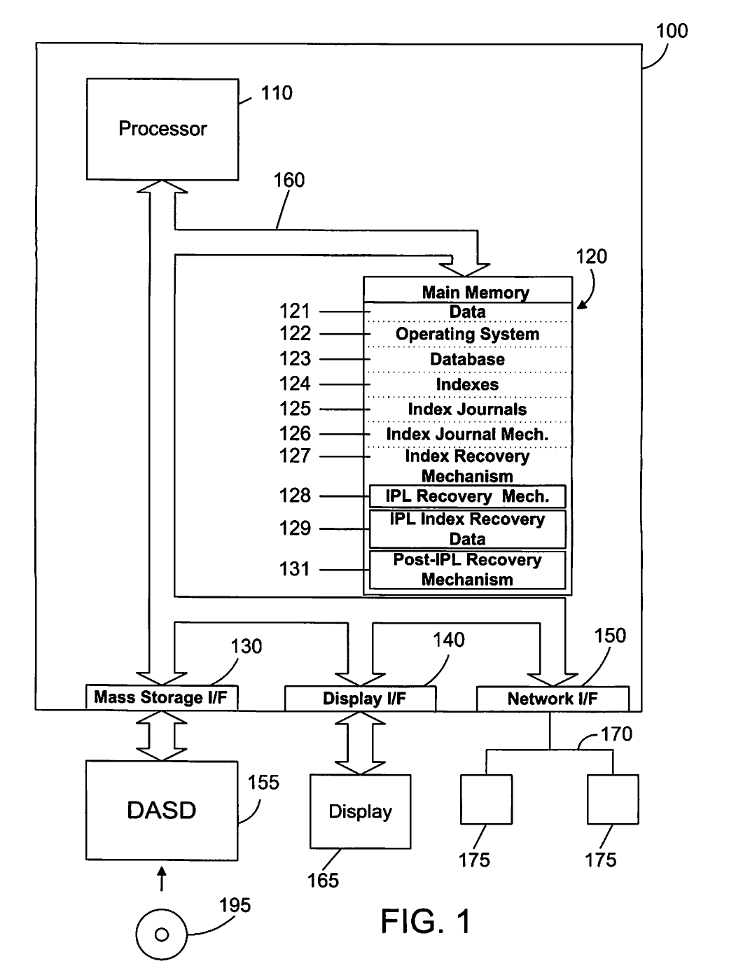

Referring to FIG. 1, a computer system 100 is one suitable implementation of an apparatus in accordance with the preferred embodiments of the invention. Computer system 100 is an IBM eServer System i computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 in accordance with the preferred embodiments contains data 121, an operating system 122, a database 123, one or more indexes 124, one or more index journals 125, an index journal mechanism 126, and an index recovery mechanism 127. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. Database 123 is any suitable database, whether currently known or developed in the future. Indexes 124 include one or more indexes that are built to speed access to data in a table in the database 123. Index journals 125 contain journal data that allow recovering one or more indexes. The index journals 125 are generated by the index journal mechanism 126, which stores the index journals 125 so that one or more indexes may be recovered from the index journals 125 instead of having to regenerate the indexes from scratch. Note that the index journal mechanism 126 stores index journals 125 for all indexes that may be fully recovered during IPL (as in the prior art), but additionally stores index journals 125 for other indexes that may not be fully recovered during IPL.

The index recovery mechanism 127 includes an IPL recovery mechanism 128, IPL index recovery data 129, and post-IPL recovery mechanism 131. The IPL recovery mechanism 128 fully recovers all journaled indexes that may be fully recovered during IPL. In addition, the IPL recovery mechanism 128 also processes in a first stage index journals 125 for any indexes that cannot be fully recovered during IPL. The result of the first stage processing during IPL is stored as IPL index recovery data 129. Once IPL is complete, the post-IPL recovery mechanism 131 reads the stored IPL index recovery data 129, and performs a second stage of processing to complete recovery of one or more indexes. In this manner, the index journal mechanism 126 stores index journals 125 for all indexes that may be beneficial to journal, without regard to whether or not the index can be fully recovered during IPL. The index recovery mechanism 127 then performs two stages of processing, one during IPL and the other post-IPL, to fully recover any index that was journaled, including those that cannot be fully recovered during IPL.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, indexes 124, index journals 125, index journal mechanism 126, and index recovery mechanism 127 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable media used to actually carry out the distribution. Examples of suitable computer-readable media include: recordable media such as floppy disks and CD-RW (e.g., 195 of FIG. 1), and transmission media such as digital and analog communications links.

Referring to FIG. 4, a method 400 in accordance with the preferred embodiments begins by determining whether it is beneficial to journal an index (step 420). If not (step 420=NO), the index is not journaled (step 440). If so (step 420=YES), the index is journaled (step 430). Comparing method 400 of FIG. 4 to prior art method 200 in FIG. 2 shows that method 400 will journal indexes even if they cannot be fully recovered during IPL, while prior art method 200 will not.

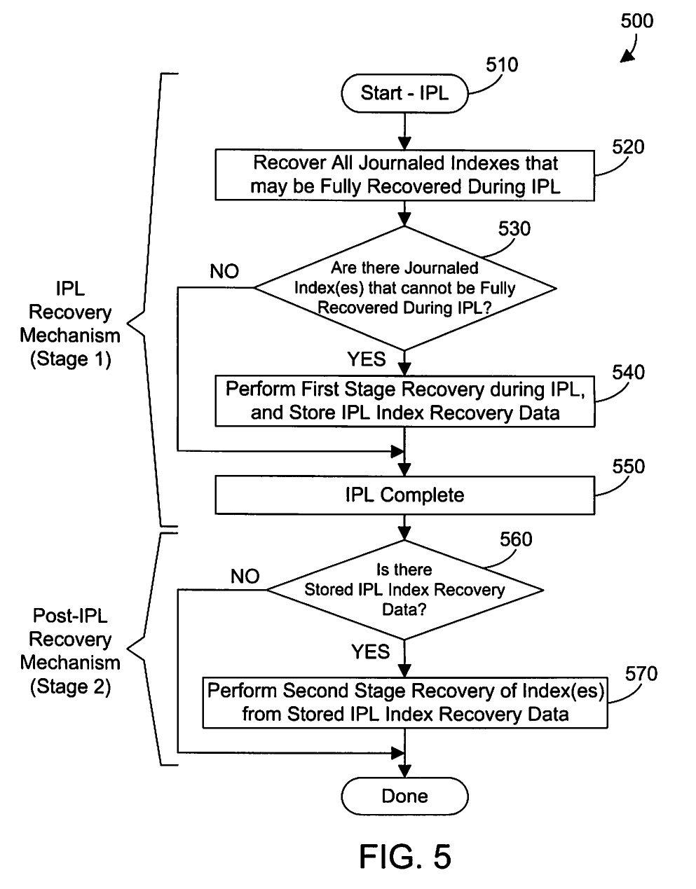

Referring to FIG. 5, a method 500 includes steps that are preferably performed by the index recovery mechanism 127 in FIG. 1. The IPL recovery mechanism 128 preferably performs steps 510-550, while the post-IPL recovery mechanism 131 preferably performs steps 560 and 570. Method 500 begins during IPL (step 510). All journaled indexes that may be fully recovered during IPL are recovered (step 520), similar to step 320 in prior art method 300 in FIG. 3. Method 500 then determines whether there are any journaled indexes that cannot be fully recovered during IPL (step 530). If not (step 530=NO), the stage 1 processing during IPL is complete (step 550). If there is any journaled index that cannot be fully recovered during IPL (step 530=YES), the first stage of recovery that can be performed during IPL is performed, and the corresponding IPL index recovery data is stored (step 540). IPL is then complete (step 550). Now that IPL is complete (step 550), the post-IPL recovery mechanism may perform its tasks. If there is stored IPL index recovery data (step 560=YES), this means that first stage processing was done during IPL that was not completed. The second stage recovery of any indexes that have corresponding stored IPL index recovery data is then performed (step 570). If there is no stored IPL index recovery data (step 560=NO), method 500 is done.

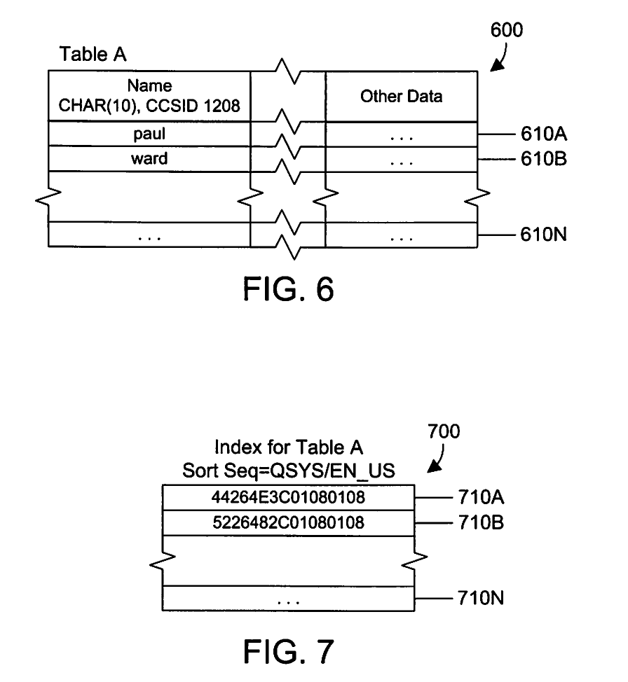

The preferred embodiments extend to any two-stage recovery of indexes where the first stage is performed during IPL and the second stage is performed after IPL is complete. One type of index that may be processed in this two-stage system is an index that includes a user-defined function. User-defined functions are not available until after IPL is complete, so an index that references a user-defined function is not journaled in the prior art. However, with the index recovery mechanism of the preferred embodiments, the index is partially recovered during IPL during the first stage, and is then completely recovered using the user-defined function after IPL during the second stage. A simple example is now presented in FIGS. 6-9 to illustrate recovery of an index that includes a user-defined function.

Referring to FIG. 6, we assume a database table 600 includes a column Name that has a type of CHAR(10) for Character Code Set ID (CCSID) 1208. The table includes a first entry 610A that includes the name “paul” in the Name column, and a second entry 610B that includes the name “ward” in the Name column. Other entries, e.g. 610N, also exist in the table, but are not shown to simplify this example. We now assume that an index 700 shown in FIG. 7 is defined for Table A 600 in FIG. 6. Index 700 has a key that is defined by a sort sequence table QSYS/EN_US, which is implemented with a system user-defined function. The QSYS/EN_US sort sequence table uses the system user-defined function to generate a key value in hexadecimal format of 44264E3C01080108 for the name “paul”, as shown in entry 710A in the index 700. The QSYS/EN_US sort sequence table uses the system user-defined function to generate a key value in hexadecimal format of 5226482C01080108 for the name “ward”, as shown in entry 710B in the index 700. There may be other entries (e.g., entry 710N) in the index 700 that are not shown to simplify this example.

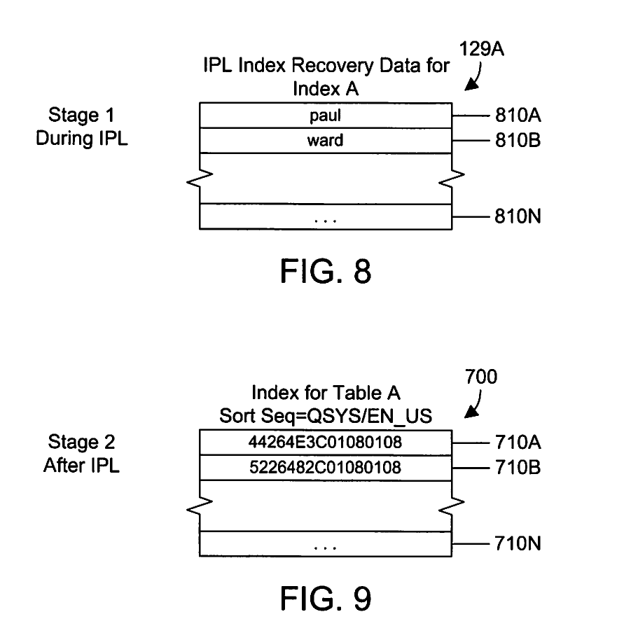

We assume as shown in method 400 in FIG. 4 that journaling this index 700 in FIG. 7 is beneficial (step 420=YES), which results in journal data being saved for index 700 (step 430). The journal data allows recovering the index without generating the index anew from scratch. We now review how this index 700 in FIG. 7 can be recovered from journal data using the two-stage recovery process shown in FIG. 5. Step 540 in FIG. 5 results in the partial recovery of the index. Note, however, that the user-defined function that implements the QSYS/EN_US sort sequence table is not available during IPL. As a result, full recovery of the index 700 from the journal data is not possible during IPL. The first stage processing generates index recovery data 129A shown in FIG. 8, which includes the names “paul” and “ward” in the key column, shown in entries 810A and 810B, respectively. Once IPL is complete, the second stage recovery can be performed in step 570 in FIG. 5 by reading the index recovery data 129A shown in FIG. 8, and using the user-defined function to implement the QSYS/EN_US sort sequence table to generate the appropriate key values shown in index 700 in FIG. 9. Note that the recovered index 700 shown in FIG. 9 is identical to the original index 700 shown in FIG. 7, as it should be. This simple example illustrates how recovery of an index that cannot be fully recovered during IPL can be recovered using a two-stage process, where the first stage is performed during IPL and the second stage is performed after IPL is complete.

An index recovery mechanism allows journaling and recovering indexes that cannot be fully recovered during IPL. A first stage of processing is performed during IPL to generate index recovery data, which is then stored. A second stage of processing is performed after IPL is complete by reading the stored index recovery data, then processing this data to complete the recovery of the index. By performing index recovery in two separate stages for indexes that cannot be fully recovered during IPL, the preferred embodiments allow journaling and recovering indexes that are not journaled nor recovered in the prior art.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, while user-defined functions are described herein as one specific type of function that is not available during IPL, other types of key-string processing may be performed after IPL is complete to assure proper sort sequence. The preferred embodiments expressly extend to any and all two-stage index recovery, with the first stage during IPL and the second stage after IPL is complete, regardless of the reason for performing the two-stage recovery.

What is claimed is:

1. An apparatus comprising:
at least one processor;
a memory coupled to the at least one processor;
a database residing in the memory;
an index residing in the memory;
a journal mechanism that stores journal data for the index; and
an index recovery mechanism residing in the memory and executed by the at least one processor that performs a first stage of processing of the journal data during initial program load and performs a second stage of processing to recover the index after the initial program load is complete.

2. The apparatus of claim 1 further comprising:
index recovery data generated and stored by the index recovery mechanism during the initial program load.

3. The apparatus of claim 2 wherein the index recovery data is read by the index recovery mechanism after the initial program load to recover the index.

4. The apparatus of claim 1 wherein the initial program load comprises a boot sequence for the apparatus.

5. The apparatus of claim 1 wherein the first stage of processing comprises complete recovery for all indexes that may be completely recovered during the initial program load.

6. The apparatus of claim 1 wherein the second stage of processing is only performed for indexes that may not be completely recovered during the initial program load.

7. The apparatus of claim 6 wherein a selected index may not be completely recovered during initial program load when the selected index includes a user-defined function that is not available during the initial program load.

8. A computer-implemented method for recovering an index for a database, the method comprising the steps of:
storing journal data for the index;
performing a first stage of processing of the journal data during initial program load; and
performing a second stage of processing to recover the index after the initial program load is complete.

9. The method of claim 8 wherein the first stage of processing produces index recovery data that is stored during the initial program load.

10. The method of claim 9 wherein the second stage of processing reads the index recovery data after the initial program load to recover the index.

11. The method of claim 8 wherein the initial program load comprises a boot sequence.

12. The method of claim 8 wherein the first stage of processing comprises complete recovery for all indexes that may be completely recovered during the initial program load.

13. The method of claim 8 wherein the second stage of processing is only performed for indexes that may not be completely recovered during the initial program load.

14. The method of claim 13 wherein a selected index may not be completely recovered during initial program load when the selected index includes a user-defined function that is not available during the initial program load.

15. A computer-readable program product comprising:
an index recovery mechanism that performs a first stage of processing of index journal data during initial program load and performs a second stage of processing to recover the index after the initial program load is complete; and
recordable media bearing the index recovery mechanism.

16. The program product of claim 15 further comprising:
index recovery data generated and stored by the index recovery mechanism during the initial program load and read by the index recovery mechanism after the initial program load to recover the index.

17. The program product of claim 15 wherein the initial program load comprises a boot sequence.

18. The program product of claim 15 wherein the first stage of processing comprises complete recovery for all indexes that may be completely recovered during the initial program load.

19. The program product of claim 15 wherein the second stage of processing is only performed for indexes that may not be completely recovered during the initial program load.

20. The program product of claim 19 wherein a selected index may not be completely recovered during initial program load when the selected index includes a user-defined function that is not available during the initial program load.
